(19) United States
(12) Patent Application Publication
(10) Pub. No.: US 2012/0024634 A1
(43) Pub. Date: Feb. 2, 2012

(54) Spring paddle propulsion device

(76) Inventor: James Walker, Capistrano Beach, CA (US)

(21) Appl. No.: 13/135,926

(22) Filed: Jul. 18, 2011

Related U.S. Application Data
(60) Provisional application No. 61/365,286, filed on Jul. 16, 2010.

(51) Int. Cl. F03G 1/10; B63H 19/08; F03G 1/02

(52) U.S. Cl. 185/37

(57) ABSTRACT

A propulsion device for propelling vehicles such as skateboards and watercraft comprises an elongate rod formed of an elastic material. The elongate rod has an upper end and a lower end, the upper end being formed to be suitable for grasping by a human hand with a foot section being connected to the lower end. The foot section may have a non-skid surface for engaging a support surface so that a person can bend the elongate rod to store energy and then release the stored energy to use the propulsion device to propel a wheeled vehicle. The foot section may alternatively have a paddle extending therefrom so that a person can bend the elongate rod to store energy and then release the stored energy to use the propulsion device to propel a watercraft.

CROSS REFERENCE TO RELATED APPLICATION

Priority is claimed based on U.S. Provisional Application 61/365,286, filed Jul. 16, 2010.

### BACKGROUND OF THE INVENTION

This invention relates generally to personal propulsion devices and particularly to a device for propelling a skateboard or a watercraft.

### SUMMARY OF THE INVENTION

A propulsion device according to the present invention for propelling vehicles such as skateboards and watercraft comprises an elongate rod formed of an elastic material. The elongate rod has an upper end and a lower end, the upper end being formed to be suitable for grasping by a human hand with a foot section being connected to the lower end.

The foot section may have a non-skid surface for engaging a support surface so that a person can bend the elongate rod to store energy and then release the stored energy to use the propulsion device to propel a wheeled vehicle.

The foot section may alternatively have a paddle extending therefrom so that a person can bend the elongate rod to store energy and then release the stored energy to use the propulsion device to propel a watercraft.

### BRIEF DESCRIPTION OF THE DRAWINGS

FIG. 1 illustrates a propulsion device according to the present invention being used to propel a person on a skateboard;

FIG. 2 illustrates a first embodiment of the invention;

FIG. 3 illustrates a second embodiment of the invention;

FIGS. 4A and 4B illustrate a third embodiment of the invention having a paddle at one end;

FIGS. 5A and 5B show a sequence of configurations that the propulsion device according to the present invention may have as it is used to propel a skateboard or the like; and

FIG. 6 shows a segmented embodiment of the invention.

### DETAILED DESCRIPTION OF THE INVENTION

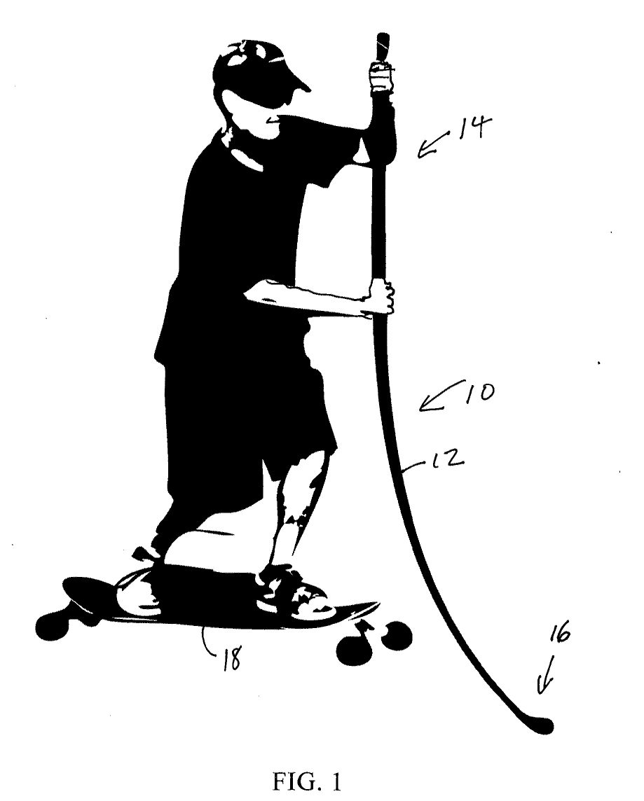

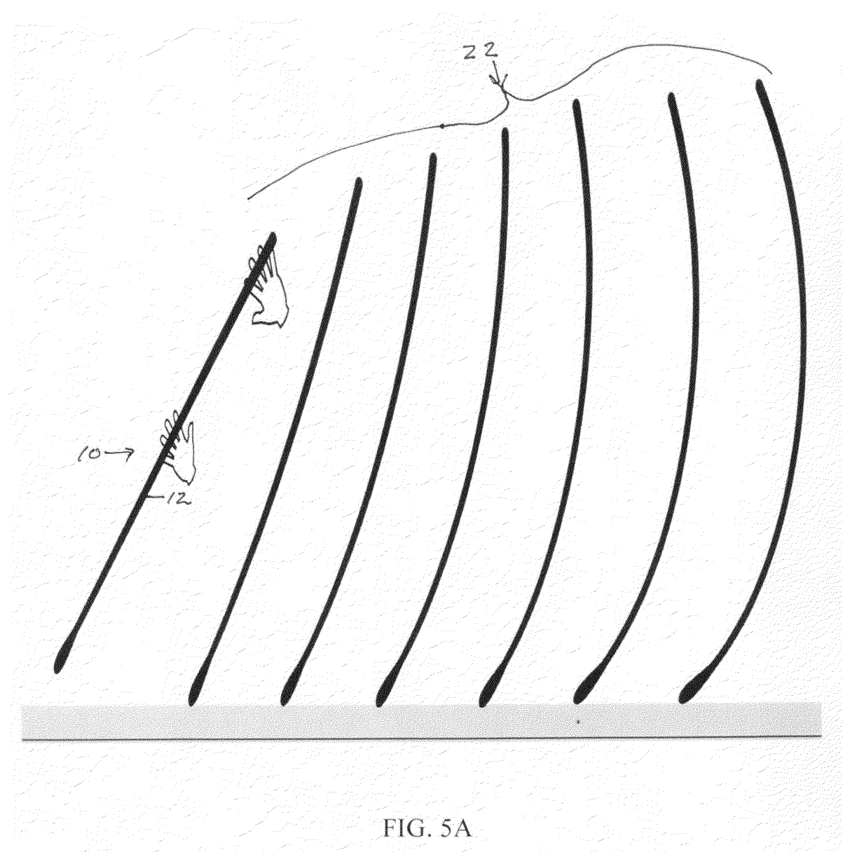

As shown in FIGS. 1-3, 4A, 4B, 5A and 5B, a propulsion device 10 according to the present invention preferably is formed to include an elongate pole 12. A first end 14 of the pole 12 is formed to be suitable for grasping by a human hand. The second end 16 may be formed to be suitable for placing on a firm surface for propelling a wheeled vehicle such as a skateboard 18 or the like as shown in FIG. 1. As shown in FIGS. 4A and 4B, the second end 16 may be flared to form a paddle 20 so that the propulsion device 10 may be used to paddle a watercraft (not shown).

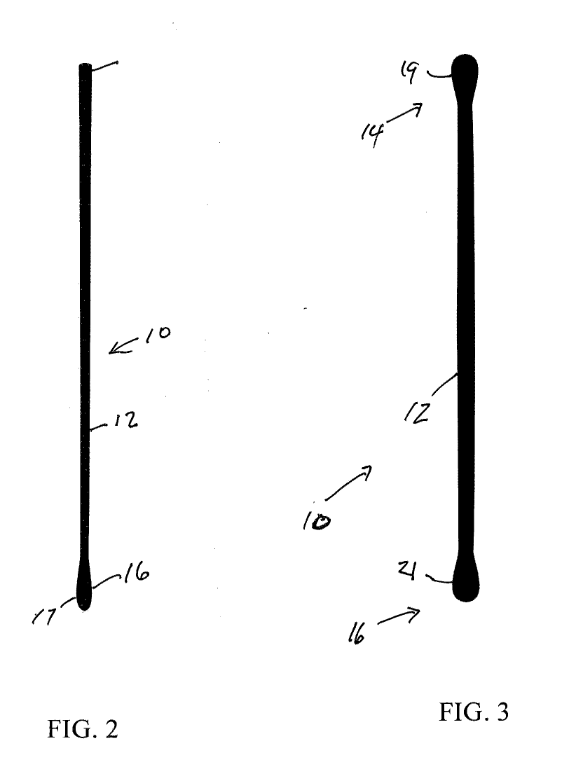

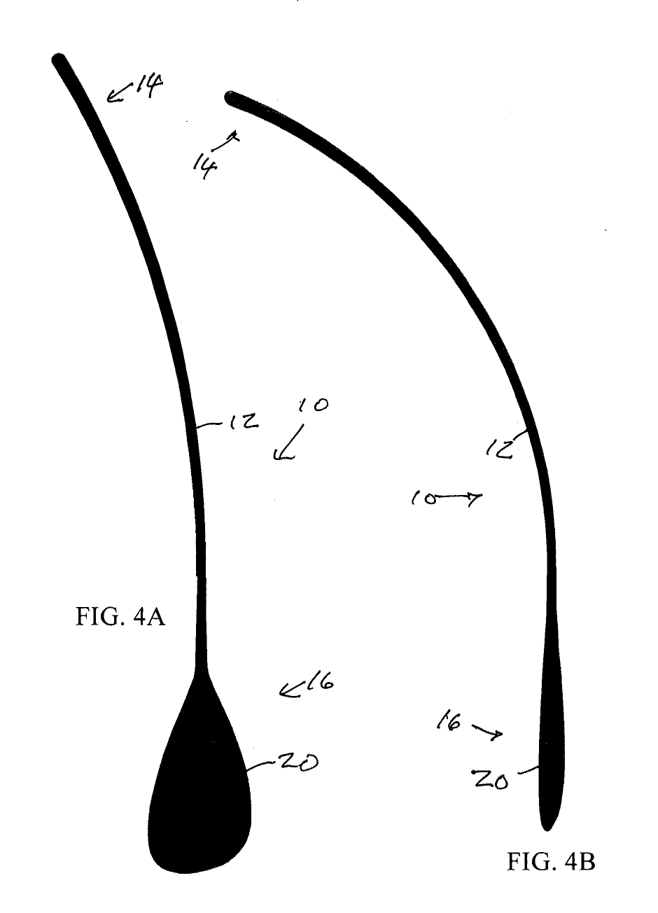

As shown in FIG. 2, the propulsion device 10 may include a single flared portion 17 at the end 16. Alternatively, the propulsion device 10 may include flared portions 19 and 21 at the opposite ends 14 and 16 as shown in FIG. 3.

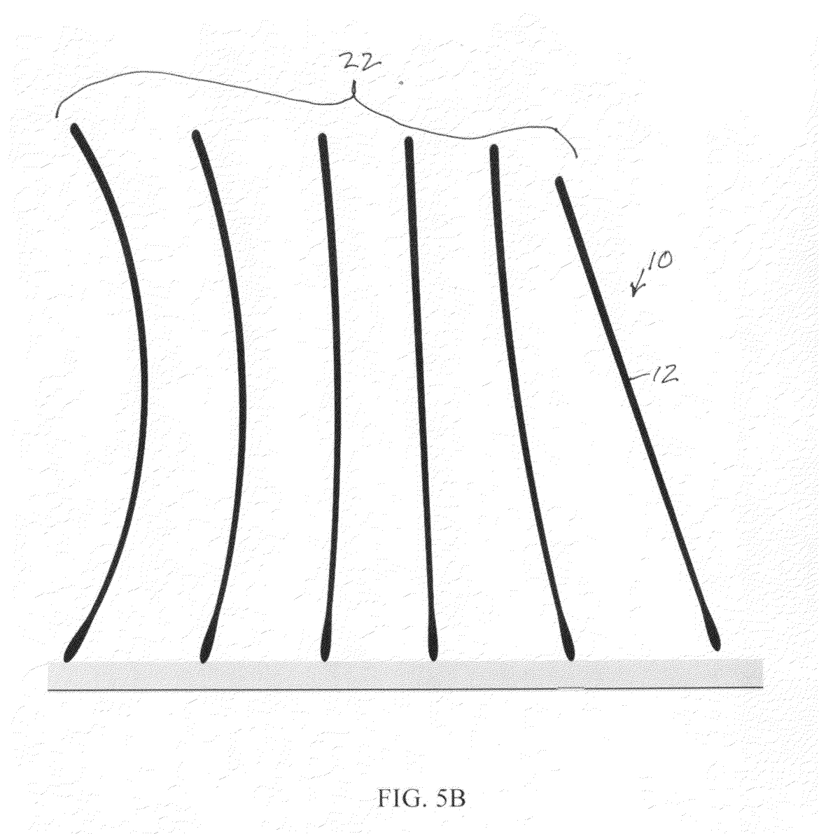

As shown in FIGS. 5A and 5B, the propulsion device 10 is somewhat elastic so that it may be flexed to form a bow 22 having energy stored therein. The propulsion device 10 then begins to straighten as energy is transferred from the propulsion device 10 into kinetic energy of the device being propelled.

The propulsion device 10 according to the present invention may be formed of any material such as carbon fiber, fiberglass or any of several plastic materials that are sufficiently elastic so that they will return to a straight configuration after being flexed.

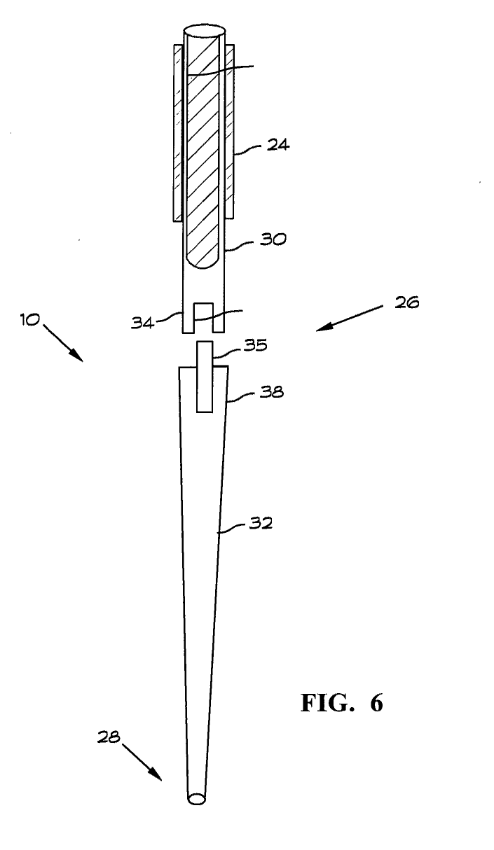

The present invention is a lightweight portable resilient spring-actuated propulsion device having a variable shaft of 4 to 7 feet in length exhibiting properties of good bending recovery, hoop strength, modulus of elasticity, torsional strength, impact strength and tenacity including sufficient flexural fatigue life. The tubular tapered hollow resilient rod 12 may include a rubber molded over-grip handle section 24 as shown in FIG. 6, a mid section 26 and a tip section 28 that connects to a plurality of footer combinations of a various blade or paddle sections for spring actuated propulsion for operators of stand-up paddle-boards, kayaks and canoes. The tubular tapered hollow resilient rod tip 28 can attach to an additional non-skid foot section engaging a support surface suitable for variable resistance exercise including spring actuated propelling of skateboards or any similar lightweight wheeled device. The construction of a tubular tapered hollow resilient rod spring propulsion device preferably uses high strength wrapped layers of angular and unidirectional glass and graphite fibers in sheets to fabricate either a single monolithic tubular tapering shaft or a variable set of smaller modular tubular tapering shafts conjoined together as shown in FIG. 6.

Referring to FIG. 6 the rod 12 may comprise a pair of segments 30 and 32. An end 34 of the segment 30 has a recess 35 formed therein for receiving a projection 36 formed at and end 38 of the segment 32. Forming the propulsion device 10 in two or more sections allows it to be packaged in a manner that is convenient for shipping, storage and display.

The multi-function propulsion device 10 according to the present invention interchangeably embodies an exercise apparatus that enables an individual to perform a variety of aerobic, isometric, isotonic and stretching exercises utilizing variable resistance forces provided for in strength and endurance training including physical therapy.

What is claimed is:

1. A propulsion device for propelling vehicles such as skateboards and watercraft, comprising: an elongate rod formed of an elastic material; the elongate rod having an upper end and a lower end, the upper end being formed to be suitable for grasping by a human hand; and a foot section connected to the lower end.

2. The propulsion device of claim 1 wherein the foot section has a non-skid surface for engaging a support surface so that a person can bend the elongate rod to store energy and then release the stored energy to use the propulsion device to propel a wheeled vehicle.

3. The propulsion device of claim 1 wherein the foot section has a paddle extending therefrom so that a person can bend the elongate rod to store energy and then release the stored energy to use the propulsion device to propel a watercraft.
